(19) United States
(12) Patent Application Publication
(10) Pub. No.: US 2010/0251113 A1
(43) Pub. Date: Sep. 30, 2010

(54) PORTABLE ELECTRONIC DEVICE AND METHOD FOR CONSTRUCTING A USER INTERFACE OF THE PORTABLE ELECTRONIC DEVICE

(75) Inventor: WANG-HUNG YEH, Taoyuan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXCONN COMMUNICATION TECHNOLOGY CORP., Taoyuan County (TW)

(21) Appl. No.: 12/538,969

(22) Filed: Aug. 11, 2009

(30) Foreign Application Priority Data
Mar. 26, 2009 (CN) 200910301164.7

(51) Int. Cl. G06F 3/041; G06F 3/01

(52) U.S. Cl. 715/702; 345/173

(57) ABSTRACT

A portable electronic device and method for constructing a user interface of the portable electronic device are provided. The method predefines function combinations, constructs a coordinate system of a display area on a touch-based screen of the portable electronic device, and generates a matrix user interface based on the coordinate system. The method further divides the matrix user interface into grids, sets a coordinate value for each of the grids, and associates each of the function combinations with one of the grids according to the coordinate value. In addition, the method arranges each of the function combinations to a corresponding grid of the matrix user interface, and displays the matrix user interface on the touch-based screen.

### BACKGROUND

1. Technical Field

Embodiments of the present disclosure relate to user interfaces of portable electronic devices, and more particularly to a portable electronic device and a method for constructing a user interface of the portable electronic device.

2. Description of Related Art

As portable devices become more compact, and the amount of information to be processed increases, it has become a significant challenge to design a user interface that allows users to easily interact with the portable devices. Some conventional user interfaces may result in complicated key sequences or menu hierarchies that must be memorized by the user. These conventional user interfaces may also result in time consuming required to memorize the multiple key sequences or menu hierarchies. In particular, the required behaviors during the process of operating such conventional user interfaces are often counter intuitive and the corresponding indicators guiding user actions are often difficult to understand.

Accordingly, there is a need for an intuitive user interface for a portable electronic device that enables a user to conveniently operate a desired menu item in the user interface.

### BRIEF DESCRIPTION OF THE DRAWINGS

FIG. 1 is a schematic diagram of one embodiment of a portable electronic device.

FIG. 2 is a schematic diagram of one embodiment of a plurality of function combinations.

FIG. 3 is a schematic diagram of one embodiment of a coordinate system of a matrix user interface.

FIG. 4 is a schematic diagram of one embodiment of function combinations displayed on a matrix user interface.

FIG. 5 is a schematic diagram of one embodiment of function combinations displayed on a matrix user interface.

FIG. 6 is a flowchart of one embodiment of a method for constructing a matrix user interface of the portable electronic device of FIG. 1.

FIG. 7 is a flowchart of one embodiment of a method for operating a matrix user interface of the portable electronic device of FIG. 1.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

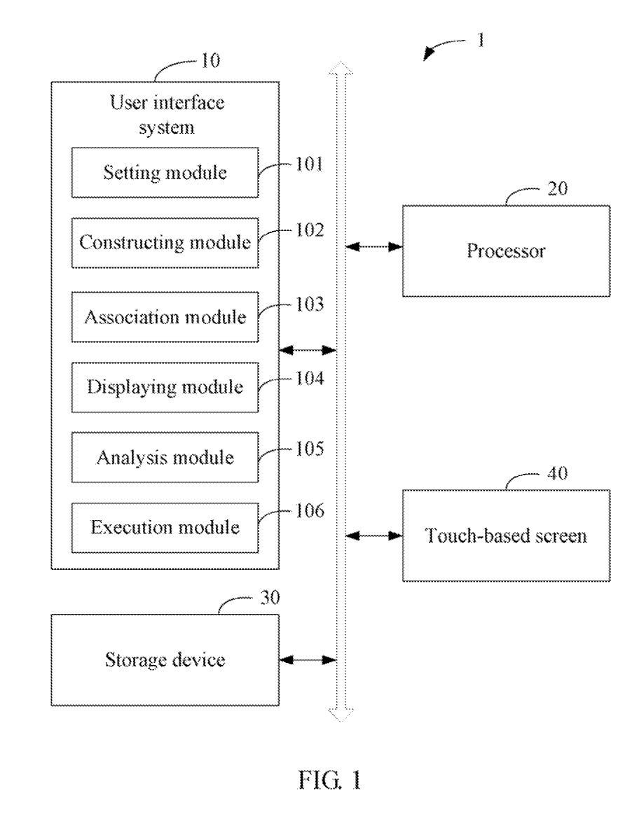

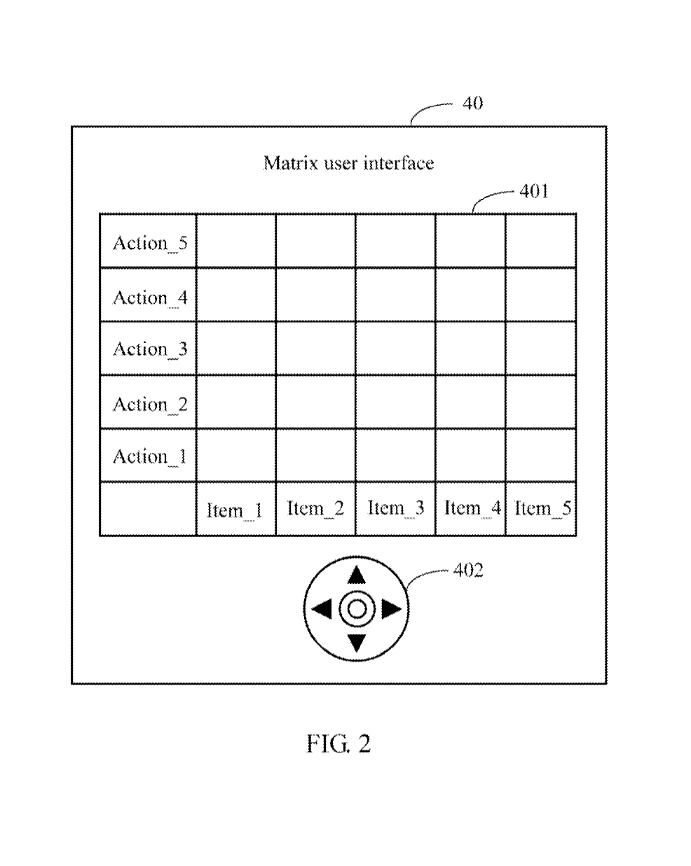

FIG. 1 is a schematic diagram of one embodiment of a portable electronic device 1. In one embodiment, the portable electronic device 1 may include a user interface system 10, at least one processor 20, a storage device 30, and a touch-based screen 40. The user interface system 10 is operable to generate and display a matrix user interface 401 (shown in FIG. 2) on the touch-based screen 40, and execute a function when a user operates the matrix user interface 401.

In the embodiment, the user interface system 10 is included in the storage device 30 or a computer readable medium of the portable electronic device 1. In another embodiment, the information user interface 10 may be included in an operating system of the portable electronic device 1, such as the UNIX, Linux, Windows 95, 98, NT, 2000, XP, Vista, Mac OS X, an embedded operating system, or any other compatible operating system.

The at least one processor 20 runs various software modules stored in the storage device 30 to perform various functions for the portable electronic device 1. The storage device 30 may store software instructions of the user interface system 10. In the embodiment, the storage device 30 may be a random access memory (RAM) for temporary storage of information and/or a read only memory (ROM) for permanent storage of information. The storage device 30 may also be a hard disk drive, an optical drive, a networked drive, or some combination of various digital storage systems. The touch-based screen 40 is operable to display the matrix user interface 401 generated by the user interface system 10. As shown in FIG. 1, the above mentioned components may be coupled by one or more communication buses or signal lines. It should be apparent that FIG. 1 is only one example of an architecture for the portable electronic device 1 that can be included with more or fewer components than shown, or a different configuration of the various components. The portable electronic device 1 can be a handheld computer, a mobile phone, or a personal digital assistant (PDA), for example.

In one embodiment, the user interface system 10 may include a setting module 101, a constructing module 102, an association module 103, a displaying module 104, an analysis module 105, and an execution module 106. Each of the function modules 101-106 may comprise one or more computerized operations that can be executed by the at least one processor 20 of the portable electronic device 1. In general, the word “module,” as used herein, refers to logic embodied in hardware or firmware, or to a collection of software instructions, written in a programming language, such as, for example, Java, C, or assembly. One or more software instructions in the modules may be embedded in a storage device, such as an EPROM. The modules described herein may be implemented as either software and/or hardware modules and may be stored in any type of computer-readable medium or other storage device.

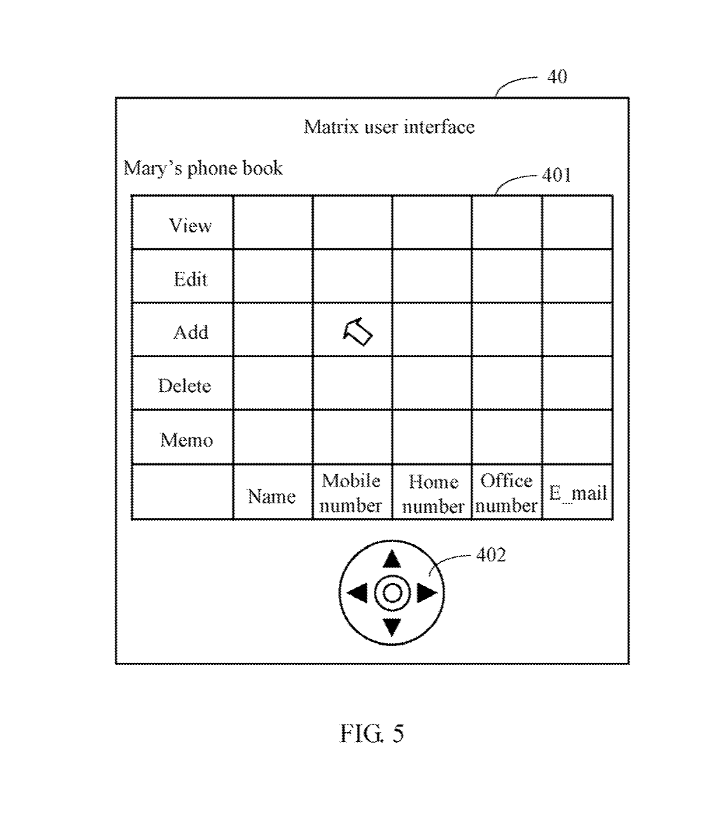

The defining module 101 is operable to define a plurality of function combinations, and set a coordinate system on the touch-based screen 40. In one embodiment, each of the function combinations is a combination of a function item and a function action. The function item is set along an X-axis of the coordinate system, and the function action is set along a Y-axis of the coordinate system. As an example, referring to FIG. 2, the setting module 101 sets “Item_1” and “Action_1” as a first function combination, sets “Item_2” and “Action_2” as a second function combination, sets “Item_3” and “Action_3” as a third function combination, sets “Item_4” and “Action_4” as a forth function combination, and sets “Item_5” and “Action_5” as a fifth function combination, although the disclosure is not limited thereto. The function items “Item_1, Item_2, Item_3, Item_4, and Item_5” are set along the X-axis of the coordinate system. The function items “Action_1, Action_2, Action_3, Action_4, and Action_5” are set along the Y-axis of the coordinate system. Each of the function items may be represent an item name. For example, referring to FIG. 5, “Item_1” may correspond to “Mary,” “Item_2” may correspond to ““Mobile number,” and “Item_3” may correspond to “Home number,” “Item_4” may correspond to “Office number,” and “Item_5” may correspond to “E-mail.” Each of the function actions may be represent an action corresponding to the function item. For example, also referring to FIG. 5, “Action_1” may correspond to “View,” “Action_2” may correspond to “Edit,” “Action_3” may correspond to “Add,” “Action_4” may correspond to “Delete,” and “Action_5” may correspond to “Memo.”

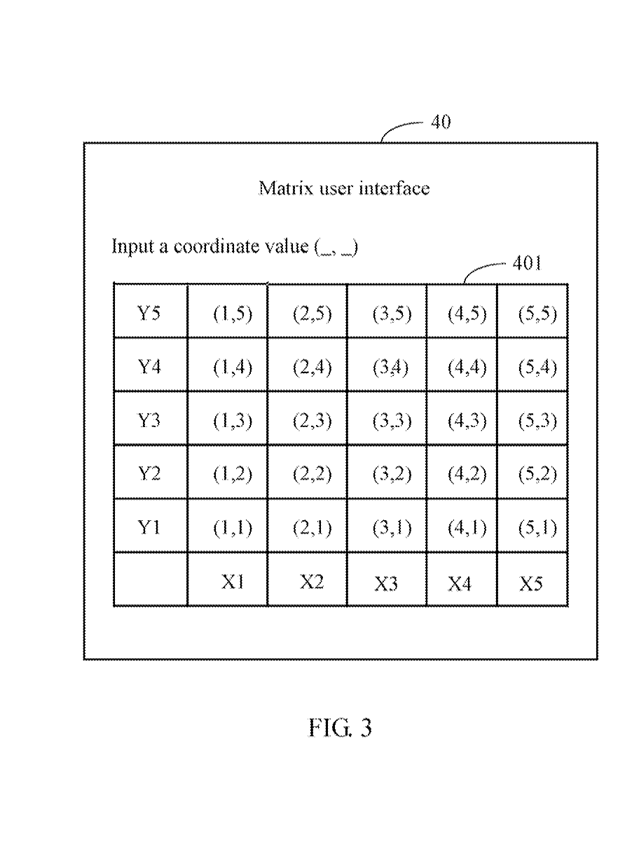

The constructing module 102 is operable to construct a matrix user interface 401 based on the coordinate system, divide the matrix user interface 401 into a plurality of grids, and set a coordinate value for each of the grids. Referring to FIG. 3, the constructing module 102 may set the coordinate value of the grid X₁Y₁ as (1, 1), set the coordinate value of the grid X₁Y₂ as (1, 2), the coordinate value of the grid X₃Y₁ as (3, 1), and set the coordinate value of the grid X₅Y₅ as (5, 5), for example.

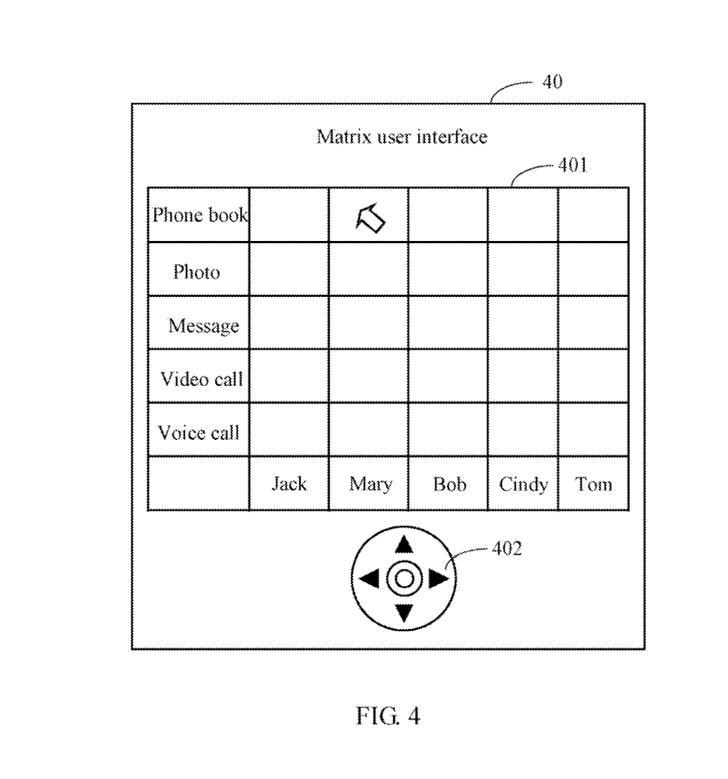

The association module 103 is operable to associate each of the function combinations with one of the grids according to the coordinate values. Referring to FIG. 2 and FIG. 3, the coordinate value of the grid X₁Y₁ (1, 1) corresponds to a first function combination that includes a function item “Item_1” and a function action “Action_1”. The coordinate value of the grid X₁Y₂ (1, 2) corresponds to a second function combination that includes a function item “Item_1” and a function action “Action_2”, for example. The association module 103 is further operable to arrange each of the function combinations to a corresponding grid of the matrix user interface 401. Referring to FIG. 4, each of the function items “Jack,” “Mary,” “Bob,” “Cindy,” and “Tom” is displayed on the matrix user interface 401 along the X-axis of the coordinate system, and each of the function actions “Phone book,” “Photo,” “Message,” “Video call,” and “Voice call” is displayed on the matrix user interface 401 along the Y-axis of the coordinate system.

The displaying module 104 is operable to display the matrix user interface 401 on the touch-based screen 40, and generate and display a selection cursor 402 on the touch-based screen 40. In one embodiment, the selection cursor 402 is used for selecting a function combination of the matrix user interface 401 when a user operates the selection cursor 402.

The analysis module 105 is operable to analyze an input coordinate value when the user touches a grid of the matrix user interface 401, detects whether a function combination is selected, and generate a detection signal when the function combination is selected. Referring to FIG. 4, when the user touches the grid X₂Y₅ on the matrix user interface 401, the analysis module 104 determines that the input coordinate value of the grid X₂Y₅ is (2, 5), for example.

The execution module 106 is operable to execute a function corresponding to the selected function combination according to the detection signal. Since each of the function combinations corresponds to an application program or instructions that are stored in the storage device 30, the execution module 106 can execute the application program to add a mobile phone number (e.g., “13800567865”) into Mary's phone book (see FIG. 5), for example.

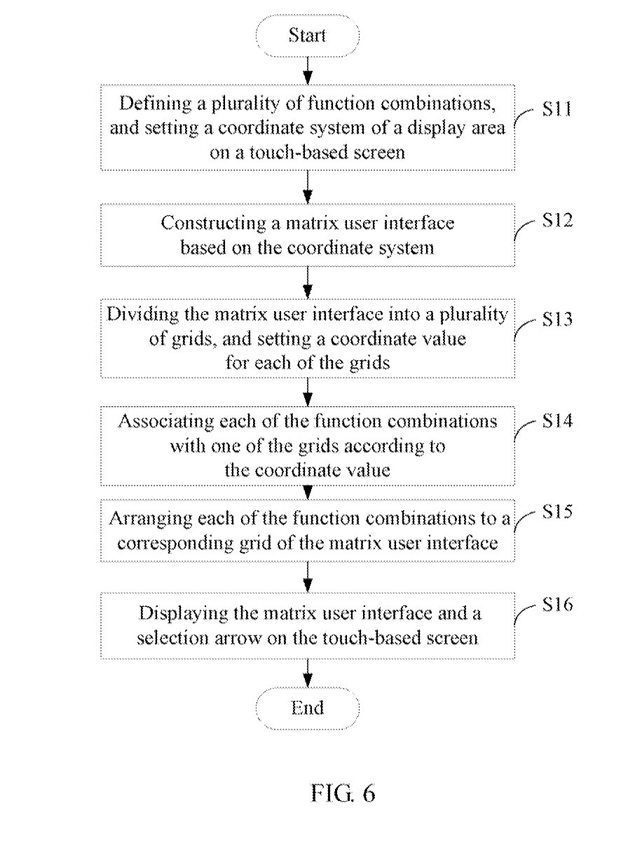

FIG. 6 is a flowchart of one embodiment of a method for constructing a matrix user interface 401 of the portable electronic device 1 as described in FIG. 1. Depending on the embodiment, additional blocks may be added, others removed, and the ordering of the blocks may be changed.

In block S11, the setting module 101 defines a plurality of function combinations, and sets a coordinate system of a display area of the touch-based screen 40. In one embodiment, each of the function combinations is a combination of a function item and a function action. The function item is set along a X-axis of the coordinate system, and the function action is set along a Y-axis of the coordinate system. As an example, referring to FIG. 2, the setting module 101 sets “Item_1” and “Action_1” as a first function combination, sets “Item_2” and “Action_2” as a second function combination, sets “Item_3” and “Action_3” as a third function combination, sets “Item_4” and “Action_4” as a forth function combination, and sets “Item_5” and “Action_5” as a fifth function combination, although the disclosure is not limited thereto. The function items “Item_1, Item_2, Item_3, Item_4, and Item_5” are set along the X-axis of the coordinate system. The function actions “Action_1, Action_2, Action_3, Action_4, and Action_5” are set along the Y-axis of the coordinate system. Each of the function items may be represent an item name. For example, referring to FIG. 5, “Item_1” may correspond to “Mary,” “Item_2” may correspond to ““Mobile number,” and “Item_3” may correspond to “Home number,” “Item_4” may correspond to “Office number,” and “Item_5” may correspond to “E-mail.” Each of the function actions may be represent an action corresponding to the function item. For example, also referring to FIG. 5, “Action_1” may correspond to “View,” “Action_2” may correspond to “Edit,” “Action_3” may correspond to “Add,” “Action_4” may correspond to “Delete,” and “Action_5” may correspond to “Memo.”

In block S12, the constructing module 102 constructs a matrix user interface 401 based on the coordinate system. In block S13, the constructing module 102 divides the matrix user interface 401 into a plurality of grids, and sets a coordinate value for each of the grids in the matrix user interface 401. Referring to FIG. 3, the constructing module 102 sets the coordinate value of the grid X₁Y₁ as (1, 1), sets the coordinate value of the grid X₁Y₂ as (1, 2), the coordinate value of the grid X₃Y₁ as (3, 1), and the coordinate value of the grid X₅Y₅ as (5, 5), for example.

In block S14, the association module 103 associates each of the function combinations with one of the grids according to the coordinate value. Referring to FIG. 2 and FIG. 3, the coordinate value of the grid X₁Y₁ (1, 1) corresponds to a first function combination that includes a function item “Item_1” and a function action “Action_1”. The coordinate value of the grid X₁Y₂ (1, 2) corresponds to a second function combination that includes a function item “Item_1” and a function action “Action_2”.

In block S15, the association module 103 arranges each of the function combinations to a corresponding grid of the matrix user interface 401. Referring to FIG. 4, each of the function items “Jack,” “Mary,” “Bob,” “Cindy,” and “Tom” is displayed on the matrix user interface 401 along the X-axis of the coordinate system, and each of the function actions “Phone book,” “Photo,” “Message,” “Video call,” and “Voice call” is displayed on the matrix user interface 401 along the Y-axis of the coordinate system.

In block S16, the displaying module 104 displays the matrix user interface 401 on a touch-based screen 40, and generates and displays a selection cursor 402 on the touch-based screen 40. In the embodiment, the selection cursor 402 is used for selecting a function combination of the matrix user interface 401 when a user touches the selection cursor 402.

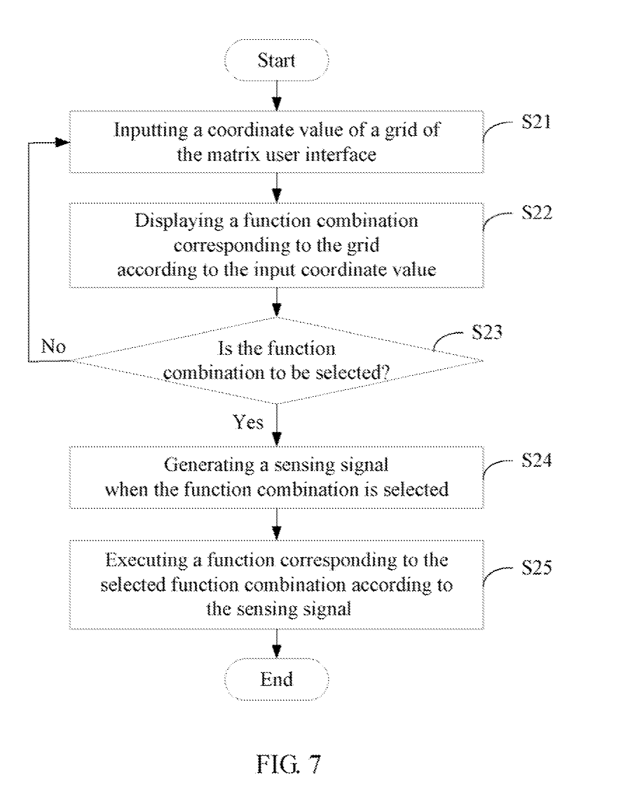

FIG. 7 is a flowchart of one embodiment of a method for operating a matrix user interface 401 of the portable electronic device 1 as described in FIG. 1. Depending on the embodiment, additional blocks may be added, others removed, and the ordering of the blocks may be changed.

In block S21, the analysis module 105 determines an input coordinate value when a grid of the matrix user interface 401 is touched. Referring to FIG. 4, when the user touches the grid X₂Y₅ on the matrix user interface 401, the analysis module 104 determines that the input coordinate value of the grid X₂Y₅ is (2, 5), for example.

In block S22, the displaying module 104 displays a function combination on the matrix user interface 401 according to the input coordinate value. For example, if the user touches the grid X₂Y₅ on the matrix user interface 401 as shown in FIG. 4, the displaying module 104 then displays the function combination denoted as “Mary's phone book” on the matrix user interface 401 as shown in FIG. 5. For example, each of the function items “Mary,” “Mobile number,” “Home number,” “Office number,” and “E-mail” is displayed on the matrix user interface 401 along with the X-axis of the coordinate system, and each of the function actions “View,” “Edit,” “Add,” “Delete,” and “Memo” is displayed on the matrix user interface 401 along with the Y-axis of the coordinate system.

In block S23, the analysis module 105 detects whether a function combination is selected. If no function combination is selected, the procedure returns to block S21 as described above. Otherwise, if a function combination is selected, in block S24, the analysis module 105 generates a detection signal when a function combination is selected. With respect to FIG. 5 of the present disclosure, when the user touches the grid X₂Y₃ on the matrix user interface 401, the analysis module 105 generates the detection signal, and then determines that the function combination denoted as “Adding a mobile phone number to Mary's phone book” is selected.

In block S25, the execution module 106 executes a function corresponding to the selected function combination according to the detection signal. As mentioned in above, each of the function combinations corresponds to an application program or instructions that are stored in the storage device 30. Therefore, the user can add a mobile phone number “13800567865” into Mary's phone book by executing the application program to (refer to FIG. 5) via the execution module 106, for example.

All of the processes described above may be embodied in, and fully automated via, functional code modules executed by one or more general purpose processors of electronic devices. The functional code modules may be stored in any type of readable medium or other storage devices. Some or all of the methods may alternatively be embodied in specialized the electronic devices.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A portable electronic device, comprising:
a storage device operable to store a user interface system; and
at least one processor operable to execute the user interface system, the user interface system comprising:
a setting module operable to define a plurality of function combinations, and set a coordinate system of a display area on a touch-based screen of the portable electronic device;
a constructing module operable to construct a matrix user interface based on the coordinate system, divide the matrix user interface into a plurality of grids, and set a coordinate value for each of the grids;
an association module operable to associate each of the function combinations with one of the grids according to the coordinate value, and arrange each of the function combinations to a corresponding grid of the matrix user interface; and
a displaying module operable to display the matrix user interface on the touch-based screen.

2. The portable electronic device according to claim 1, wherein the user interface system further comprises an analysis module operable to detect whether one of the function combinations is touched, and generate a detection signal according to the touched function combination.

3. The portable electronic device according to claim 2, wherein the user interface system further comprises an execution module operable to execute a function corresponding to the touched function combination according to the detection signal.

4. The portable electronic device according to claim 1, wherein the displaying module is further operable to generate a selection cursor for selecting a function combination on the matrix user interface, and display the selection cursor on the touch-based screen.

5. The portable electronic device according to claim 1, wherein each of the function combinations a function item and a function action, with the function item being set along a X-axis of the coordinate system, and the function action being set along a Y-axis of the coordinate system.

6. The portable electronic device according to claim 1, wherein each of the function combinations corresponds to an application program or instructions that are stored in the storage device.

7. A method for constructing a user interface of a portable electronic device, the method comprising:
defining a plurality of function combinations;
constructing a coordinate system of a display area on a touch-based screen of the portable electronic device;
generating a matrix user interface based on the coordinate system;
dividing the matrix user interface into a plurality of grids;
setting a coordinate value for each of the grids in the matrix user interface;
associating each of the function combinations with one of the grids according to the coordinate value;
arranging each of the function combinations to a corresponding grid of the matrix user interface; and
displaying the matrix user interface on the touch-based screen.

8. The method according to claim 7, further comprising:
generating a selection cursor to select a function combination of the matrix user interface;
displaying the selection cursor on the touch-based screen;
selecting a function combination on the matrix user interface by operating the selection cursor; and
executing a function corresponding to the selected function combination.

9. The method according to claim 7, further comprising:
receiving an input coordinate value when a grid of the matrix user interface is touched;
detecting whether a function combination is selected according to the input coordinate value;
generating a detection signal when the function combination is selected; and
executing a function according to the detection signal.

10. The method according to claim 7, wherein each of the function combinations comprises a function item and a function action, with the function item being set along a X-axis of the coordinate system, and the function action being set along a Y-axis of the coordinate system.

11. The method according to claim 7, wherein each of the function combinations corresponds to an application program or instructions that are stored a storage device of the portable electronic device.

12. A readable medium having stored thereon instructions that, when executed by at least one processor of a portable electronic device, cause the processor to perform a method for constructing a user interface of the portable electronic device, the method comprising:
defining a plurality of function combinations;
constructing a coordinate system of a display area on a touch-based screen of the portable electronic device;
generating a matrix user interface based on the coordinate system;
dividing the matrix user interface into a plurality of grids;
setting a coordinate value for each of the grids in the matrix user interface;
associating each of the function combinations with one of the grids according to the coordinate value;
arranging each of the function combinations to a corresponding grid of the matrix user interface; and
displaying the matrix user interface on the touch-based screen.

13. The medium according to claim 12, wherein the method further comprises:
generating a selection cursor to select a function combination of the matrix user interface;
displaying the selection cursor on the touch-based screen;
selecting a function combination on the matrix user interface by operating the selection cursor; and
executing a function corresponding to the selected function combination.

14. The medium according to claim 12, wherein the method further comprises:
receiving an input coordinate value when a grid of the matrix user interface is touched;
detecting whether a function combination is selected according to the input coordinate value;
generating a detection signal when the function combination is selected; and
executing a function according to the detection signal.

15. The medium according to claim 12, wherein each of the function combinations comprises a function item and a function action, with the function item being set along a X-axis of the coordinate system, and the function action being set along a Y-axis of the coordinate system.

16. The medium according to claim 12, wherein each of the function combinations corresponds to an application program or instructions that are stored a storage device of the portable electronic device.
